(19) United States
(12) Patent Application Publication
(10) Pub. No.: US 2017/0259481 A1
(43) Pub. Date: Sep. 14, 2017

(54) HOT RUNNER SYSTEM AND ASSOCIATED NOZZLE HEATING DEVICES

(71) Applicant: Otto Manner Innovation GmbH, Bahlingen am Kaiserstuhl (DE)

(72) Inventors: Christian SLISSE, Rixheim (FR); George OLARU, Freiburg (DE); Satinder SINGH, Botzingen (DE)

(21) Appl. No.: 15/454,541

(22) Filed: Mar. 9, 2017

(30) Foreign Application Priority Data
Mar. 10, 2016 (DE) 10 2016 203 995.4

(51) Int. Cl. B29C 45/27; B29C 45/28; B29C 45/78; B29C 45/03

(52) U.S. Cl. CPC B29C 45/2737; B29C 45/03; B29C 45/2725; B29C 45/28; B29C 45/78; B29C 2045/274; B29C 2045/2761; B29C 2945/7604; B29C 2945/7618; B29C 2945/76531; B29K 2105/0067

(57) ABSTRACT

A hot runner injection molding apparatus includes a hot runner nozzle and a first heater coupled to the nozzle body of the nozzle. A separate mold gate insert surrounds a nozzle tip area of the nozzle. The mold gate insert is heated by a second heater that is separate and independent from the nozzle body heater. The temperature generated by the first and second heaters is measured by a first thermocouple and a second thermocouple, respectively. A controller is used to adjust at any time the temperature of the first and second heaters independently. The second heater is used to either i) melt, and thus enable a faster removal of, a colder molten material accumulated around the nozzle tip during a color change procedure or ii) to reduce or increase the temperature of the nozzle tip differently from one nozzle to the next.

### TECHNICAL FIELD

The disclosure relates to hot runner nozzles for injection molding and associated heating devices for controlling the temperature of the hot runner nozzles.

### BACKGROUND

Injection molding hot runner systems are known. Depending on the application and other considerations, the hot runner systems can be used as thermal gating nozzles or valve gating nozzles. Reference is made in this regard to U.S. Pat. Nos. 6,609,902 and 6,921,257 showing thermal gating hot runner nozzles. Further reference is made in this regard to U.S. Pat. Nos. 6,921,259 and 8,419,417 showing valve gating hot runner nozzles.

The known thermal gating nozzles or valve gating nozzles work properly for some moldable parts, for some plastic resins and for some applications. Nevertheless, in many practical applications and instances the known hot runner nozzles are designed differently to ensure an improved control of the heat profile along the nozzle and especially at the areas around the end of the nozzle tip and in the proximity of the mold gate orifice. Reference is made in this regard to U.S. Pat. Nos. 5,061,174, 5,871,786, and 7,914,271 disclosing thermal gating hot runner nozzles. Further reference is made in this regard to U.S. Pat. No. 5,470,219 and to WO 2015/105817 disclosing valve gating hot runner nozzles.

During injection molding, the nozzle tip area is generally colder than the middle portion of the nozzle, due to heat losses to the mold near the mold cavity orifice, where the nozzle tip is located. As a result, a melt pre-chamber of a nozzle is for example colder than the melt channel. If the temperature in the melt channel is too low in some areas, for example in the area of the contact surface between nozzle tip and mold cavity orifice, several process issues can arise as for example difficulties with the start up or with color changes. In the same way, issues with molded product quality can arise as for example a raised injection gate or inclusions of “chips” of premature solidified melt.

Based on this, there is a need to further improve the hot runner nozzles mentioned above and similar for applications that require a faster color change between batches of molded articles in order to reduce the waste of material and to improve the productivity.

There is a need to further improve the hot runner nozzles mentioned above and similar for applications that require highly accurate and visually esthetic molded articles in order to reduce the number of rejected parts and also to meet the demands by an application or a client.

There is a need to further improve the hot runner nozzles mentioned above and similar for applications that require a more balanced heat profile along the nozzle in order to be able to mold articles of various materials that require a wider operating window of the nozzle.

### SUMMARY

An injection molding apparatus according to the present invention may comprise a manifold having a manifold inlet to receive molten plastic material or resin and a plurality of manifold outlets. The injection molding apparatus may comprise a plurality of hot runner nozzles coupled to the manifold outlets and located in individual bores of a mold plate. Each hot runner nozzle may include a nozzle body and a nozzle tip. The hot runner nozzle may further include a first heating element coupled to the nozzle body and a first thermocouple for measuring an amount of heat generated by the first heating element.

The injection molding apparatus may further comprise a plurality of mold gate inserts located in the bores of the mold plate and in the proximity of the nozzle tips. The mold gate inserts may be separated from the nozzles and from the nozzle tips to prevent direct contact and heat transfer between them and to allow the removal of nozzles via an axial translation relative to the mold gate inserts. The mold gate inserts may have an inner surface an outer surface and a mold cavity surface that forms at least a portion of a mold cavity adjacent to the mold gate orifice. Each mold gate insert may be heated by a second heating element, wherein an amount of heat generated by the second heating element is measured by a second thermocouple.

The injection molding apparatus may further comprise a plurality of nozzle seals which are coupled to the nozzles. The nozzle seal may make contact with the inner surface of the mold gate insert providing sealing and an alignment of the nozzle with respect to the mold gate orifice. The nozzle seals may further limit a heat transfer from the nozzle to the mold gate insert when the second heating element is activated. The injection molding apparatus may also comprise a controller configured to receive temperature data from the first thermocouple and the second thermocouple for adjusting independently the first heating element and the second heating element.

In the inventive injection molding machine, the nozzles may be arranged in mold gate inserts which are heated by a second heating element. The mold gate inserts may define the interface between the hot runner nozzles and the mold. The amount of heat of the second heating element may be measured by a second thermocouple independently adjustable via a controller of the injection molding apparatus. Based on at least the data received from the second thermocouple, the heat output of the second heating element may be adjustable by means of the controller for compensating the heat loss to the mold near the mold cavity orifice.

The manifold inlet may receive molten plastic material or resin. In the following specification there is no distinction between the use of molten plastic material or the use of resin. The advantageous effects of the invention refer to hot runner injection molding apparatuses irrespective of the processing of resin or molten plastic material.

A hot runner injection molding apparatus may include a hot runner manifold and several nozzles coupled to the manifold. Each nozzle may include a first heater coupled to the nozzle body. The amount of heat of the first heating element may be measured by a first thermocouple. Based on at least the data received from the first thermocouple, the heat output of the first heating element may be adjustable independently from the heat output of the second heating element by means of the controller for providing a suitable heat profile along the nozzle body and in particular along the melt channel within the nozzle body.

The nozzle tip may be arranged in a mold gate insert which is heated by the second heater. The second heater may be independent from the first heater and may be placed on an outer surface of the mold gate insert.

Each nozzle may include a nozzle tip and a nozzle seal. The nozzle seal may make contact with an inner surface of the mold gate insert. The nozzle seal may be arranged at the front portion of the nozzle, in particular at the nozzle tip or at the front end of the nozzle body. The nozzle seal may define the interface between the nozzle and the mold gate insert and may serve in particular—depending on the application—for positioning and sealing the nozzle relative to the mold gate insert and the mold orifice, respectively.

The temperature generated by the first heater may be measured by the first thermocouple and the temperature generated by the second heater by the second thermocouple. The controller is used to adjust at any time the temperature of the first heater and the temperature of the second heater independently, the second heater being used to either i) heat and melt and thus enable a faster removal of a colder molten material accumulated around the nozzle tip during a color change procedure or for preventing and/or clearing a raised injection gate or ii) to reduce or increase the temperature of the nozzle tip differently from one nozzle to the next or iii) in a startup operation prior to injecting melt into the mold cavity.

Depending on the application and the processed material the nozzle seal can be manufactured from of a material i) having a lower thermal conductivity than the material of the nozzle tip to provide thermal insulation of the tip relative to the mold gate insert, or ii) having the same thermal conductivity than the material of the nozzle tip to allow a heat transfer from the mold gate insert to the nozzle tip, or iii) having a higher thermal conductivity than the material of the nozzle tip to enhance the heat transfer from the mold gate insert to the nozzle tip.

In one embodiment the hot runner nozzle is an open gating nozzle. Here, the second heating element is configured to heat up a bubble area defined between the inner surface of the mold gate insert, an outer surface of the nozzle tip, and the nozzle seal, to provide removal of a resin accumulation in the bubble area between subsequent injection steps.

In another embodiment hot runner nozzle is a valve gating nozzle. Here, the second heating element is configured to heat up the mold gate orifice to a temperature dependent on the resin/the molten material that allows removal of a resin plug formed between injection cycles.

The invention as described above is applicable with regard to hot runner nozzles in form of open gating nozzles (also known as thermal gate nozzles) or in form of valve gating nozzles (also known as valve gated or valve pin nozzles). The invention is further applicable for an injection molding apparatus comprising hot runner nozzles wherein the nozzle tip is integrally formed with the nozzle body or wherein the nozzle tip is separate from the nozzle body. Advantageous effects of the invention have a positive impact on all such injection molding apparatuses.

In one embodiment the nozzle tip is made of a different material than the nozzle body material. As different materials have different thermal conductivities, it is possible to influence the heat flow between the nozzle tip and the nozzle body by means of choosing suitable materials for the nozzle body and the nozzle tip.

In one embodiment the second heating element for heating the mold gate insert is a removable heating element. Removable elements are easier to service and to replace in the case of malfunction or if a different heat output is required for different applications.

In one embodiment the second heating element for heating the mold gate insert is an embedded heating element. Embedded heating elements are usually arranged in special designed and positioned receiving grooves at the mold gate insert for enhancing the heat flow from the heating element to the mold gate insert.

One embodiment of the second heating element for heating the mold gate insert includes at least one linear cartridge heater. In another embodiment the second heating element for heating the mold gate insert includes at least one heating element having a coiled heater or a linear cartridge heater. The selection of the type of heating element depends on the application, in particular on the design of the mold and the mold gate insert (for example regarding space requirements) and on the required output of heat for the respective application.

In one embodiment the mold gate insert includes a cooling device. The cooling device is used after the injection step for cooling at least one portion of the mold gate insert arranged adjacent to the mold gate orifice for allowing a fast solidification of the molded part and thus also to shorten the injection molding cycle. In one embodiment the cooling device is water based and in another embodiment the cooling device is gas based. In particular, the cooling device is an embedded cooling device comprising cooling pipes with a cooling fluid flowing there through. The cooling pipes are in particular formed within or adjacent to the mold gate insert and in particular adjacent to the mold gate orifice.

In one embodiment a thermal insulation coating is applied on an outer surface of the mold gate insert. By means of a thermal insulation coating the heat transfer from the second heating element to the mold gate insert can be restricted. Depending on the position of the thermal insulation coating on the mold gate insert it is possible to define areas with low heat transfer (coated areas) and areas with high heat transfer (areas without coating).

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter. Other objects, advantages and novel features of the present invention will become apparent from the following detailed description of one or more preferred embodiments when considered in conjunction with the accompanying drawings.

### BRIEF DESCRIPTION OF THE DRAWINGS

The following is a description of the examples depicted in the accompanying drawings. The figures are not necessarily to scale, and certain features and certain views of the figures may be shown exaggerated in scale or in schematic in the interest of clarity or conciseness.

FIG. 1A shows an exemplary embodiment of an inventive hot runner apparatus with open nozzles for an injection molding process;

FIG. 1B shows a sectional view of an open nozzle of the exemplary embodiment from FIG. 1A in more detail;

FIG. 1C shows a sectional view of the mold gate area of the exemplary embodiment from FIG. 1A in more detail;

FIGS. 2A-2C show different views of the mold gate insert with cartridge heaters of the exemplary embodiment from FIG. 1A;

FIGS. 3A-3C show different views of the mold gate insert with a coiled heater of a further exemplary embodiment of an inventive hot runner apparatus with open nozzles;

FIGS. 4A-4C show different views of the mold gate insert with an embedded coiled heater and a cooling device of a further exemplary embodiment of an inventive hot runner apparatus with open nozzles;

FIG. 5 shows a further exemplary embodiment of an inventive hot runner apparatus with valve pin nozzles for an injection molding process;

FIGS. 6A-6D show different views of the mold gate insert with cartridge heaters of the exemplary embodiment from FIG. 5;

FIGS. 7A-7C show different views of the mold gate insert with cartridge heaters and a replaceable tip of a further exemplary embodiment of an inventive hot runner apparatus with valve gated nozzles;

FIGS. 8A-8C show different views of the mold gate insert with a coiled heater of a further exemplary embodiment of an inventive hot runner apparatus with valve gated nozzles;

FIGS. 9A-9C show different views of the mold gate insert with an embedded coiled heater and a cooling device of a further exemplary embodiment of an inventive hot runner apparatus with valve gated nozzles; and

FIG. 10 shows a schematic illustration of an exemplary embodiment of a hot runner apparatus according to the invention comprising a controller for adjusting at least the heat output of the first and second heating elements.

The foregoing summary, as well as the following detailed description of certain inventive techniques, will be better understood when read in conjunction with the figures. It should be understood that the claims are not limited to the arrangements and instrumentality shown in the figures. Furthermore, the appearance shown in the figures is one of many ornamental appearances that can be employed to achieve the stated functions of the apparatus.

### DETAILED DESCRIPTION

In the following detailed description, specific details may be set forth in order to provide a thorough understanding of embodiments of the present invention. However, it will be clear to one skilled in the art when embodiments of the present invention may be practiced without some or all of these specific details. In other instances, well-known features or processes may not be described in detail so as not to unnecessarily obscure the invention. In addition, like or identical reference numerals may be used to identify common or similar elements.

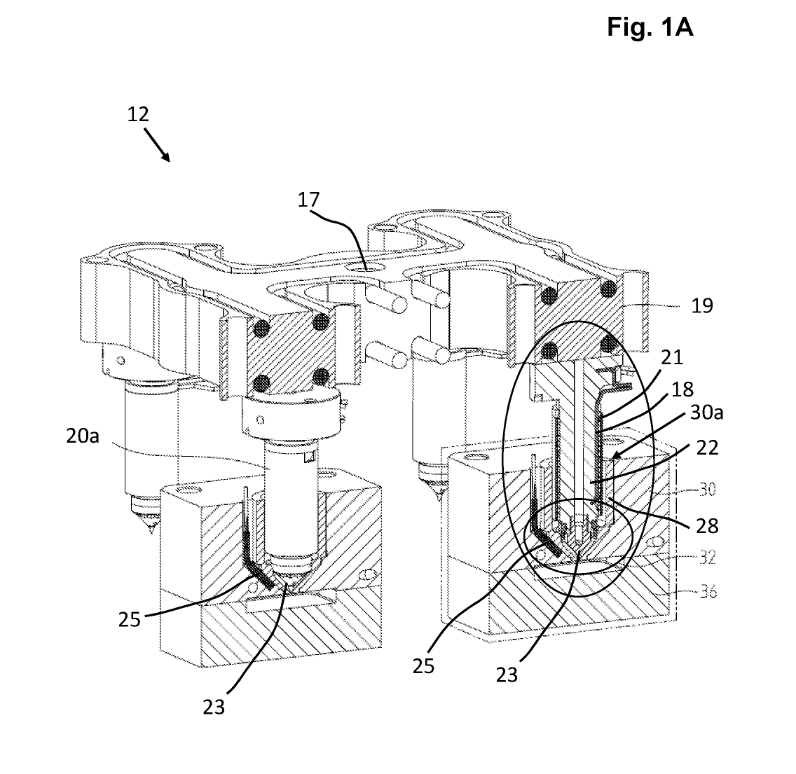

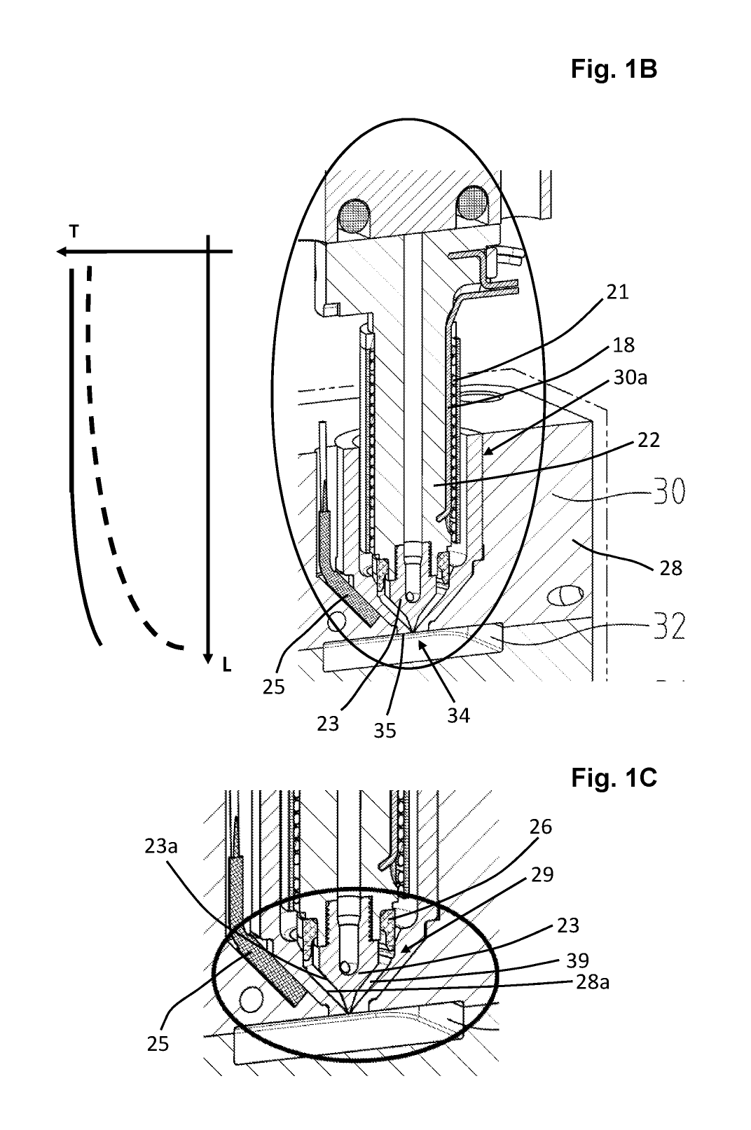

FIG. 1A shows an exemplary embodiment of an inventive hot runner apparatus 12 with thermal gating/open nozzles for an injection molding process. The hot runner apparatus 12 serves for an injection molding processes and comprises an open nozzle assembly 20 (in the exemplary embodiment having four nozzles; the number of nozzles comprised in an open nozzle assembly depends on the application and may also be two or more than four; 64 or 128 nozzles are also possible) coupled to a hot runner manifold 19 having a manifold inlet 17 to receive molten plastic material and a plurality of manifold outlets (not shown). The hot runner nozzles 20a are located in individual bores 30a of a mold plate which comprises cavity blocks 30 in the exemplary embodiment of FIG. 1A. In each cavity block 30 an impression is arranged which forms a part of the mold cavity 32.

Each hot runner nozzle 20a includes a nozzle body 22 and a nozzle tip 23, the hot runner nozzle 20a further including a first heating element 21 coupled to the nozzle body 22 and a first thermocouple 18 to measure an amount of heat generated by the first heater 21. The exemplary hot runner apparatus 12 comprises four mold gate inserts 28 located in bores 30a. In proximity of the nozzle tips 23 the mold gate inserts 28 have an inner surface 28a and an outer surface 28b and a mold cavity surface 35 that forms a portion of the mold cavity 32. Each mold gate insert 28 is heated by a second heating element 25. An amount of heat generated by the second heating element 25 is measured by a second thermocouple 31.

The exemplary hot runner apparatus 12 further comprises four nozzle seals 26 each coupled to a nozzle 20a. The nozzle seal 26 makes contact with the inner surface 28a of the mold gate insert 28 and provides sealing and an alignment of the respective nozzle 20a with respect to a mold gate orifice 34. A controller 137 (not shown in FIG. 1A) is connected to the hot runner apparatus 12 which is configured to receive temperature data from the first thermocouple 18 and the second thermocouple 31 and for adjusting the heat output of the first heating element 21 and of the second heating element 25 independently from each other.

FIG. 1B shows a sectional view of an open nozzle 20a of the exemplary embodiment as indicated by a vertical ellipse in FIG. 1A in more detail. At the left side of the illustration of the open nozzle 20a, a diagram plots the level of the temperature T within the melt channel over the length L of the hot runner nozzle 20a originating from the flange of the nozzle 20a at the manifold 19. The diagram shows in a broken line the level of the temperature in a situation where the second heating element 25 is not in use. As can be recognized from this diagram, the temperature within the melt channel of the hot runner nozzle 20a decreases constantly from the flange of the nozzle to the nozzle tip 23, wherein the temperature drop is the higher the closer the position is arranged with respect to the nozzle tip 23, where the temperature is the lowest. The nozzle tip 23 is arranged adjacent to the mold gate orifice 34 and thereby in close proximity to the cavity block 30 which has a lower temperature than the hot runner nozzle 20a.

The diagram shows in a solid line the level of the temperature in a situation where the second heating element 25 is in use. As can be recognized from this diagram, the temperature within the melt channel of the nozzle body 22 is generally higher in a situation where the second heating element 25 is in use. In a first area from the flange of the nozzle to the nozzle tip 23, the temperature is relatively constant. Only in an area closer to the nozzle tip 23 of the hot runner nozzle 20a, the temperature decreases in a direction to the mold gate orifice 34, but only to a smaller extent in comparison to a situation without heating from a second heating element 25.

The first heating element 21 is arranged at the circumference of the nozzle body 22. An outflow of heat occurs from the nozzle tip 23 into the cavity block 30, which leads to decreasing temperatures in the direction to the nozzle tip 23 and also to decreasing temperature of the melt located within the melt channel of the hot runner nozzle 20a in these areas.

In FIG. 1C a sectional view of the nozzle end portion 29 as indicated by a horizontal ellipse in FIG. 1A is shown in more detail. The illustration shows in particular the area of the nozzle tip 23 with the nozzle seal 26 arranged within the mold gate insert 28 close to the mold gate orifice 34 along with a second heating element 25. The second heating element for open gated nozzles 25 is configured to heat up a bubble area 39 defined between the inner surface 28a of the mold gate insert 28, an outer surface 23a of the nozzle tip 23, and the nozzle seal 26 to provide removal of a resin accumulation in the bubble area 39 between subsequent injection cycles.

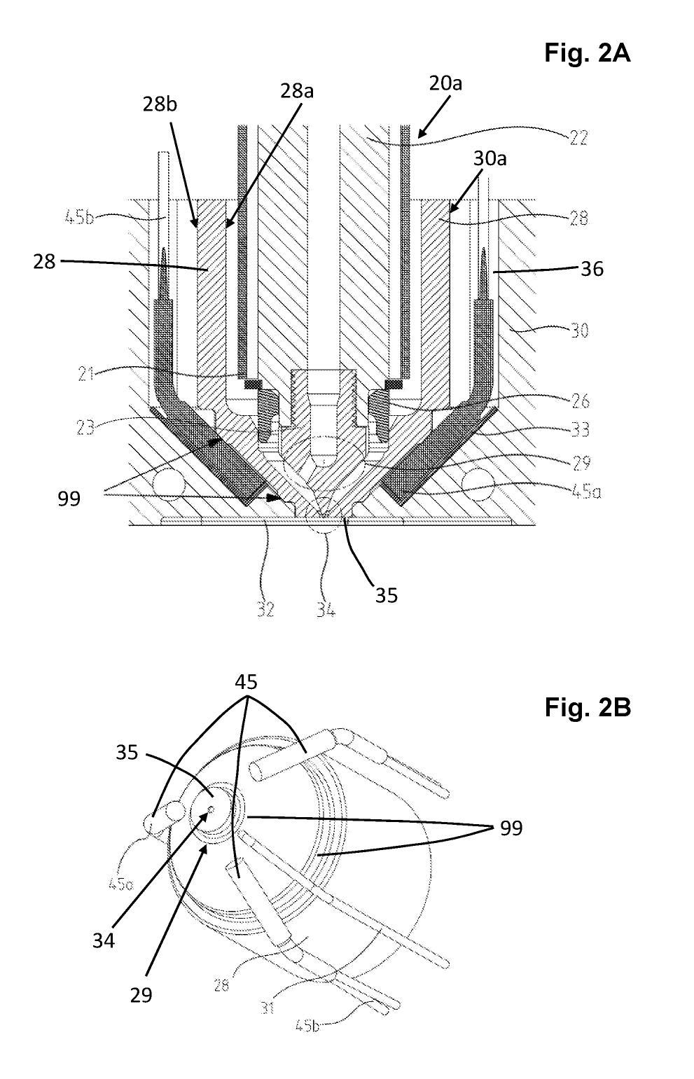

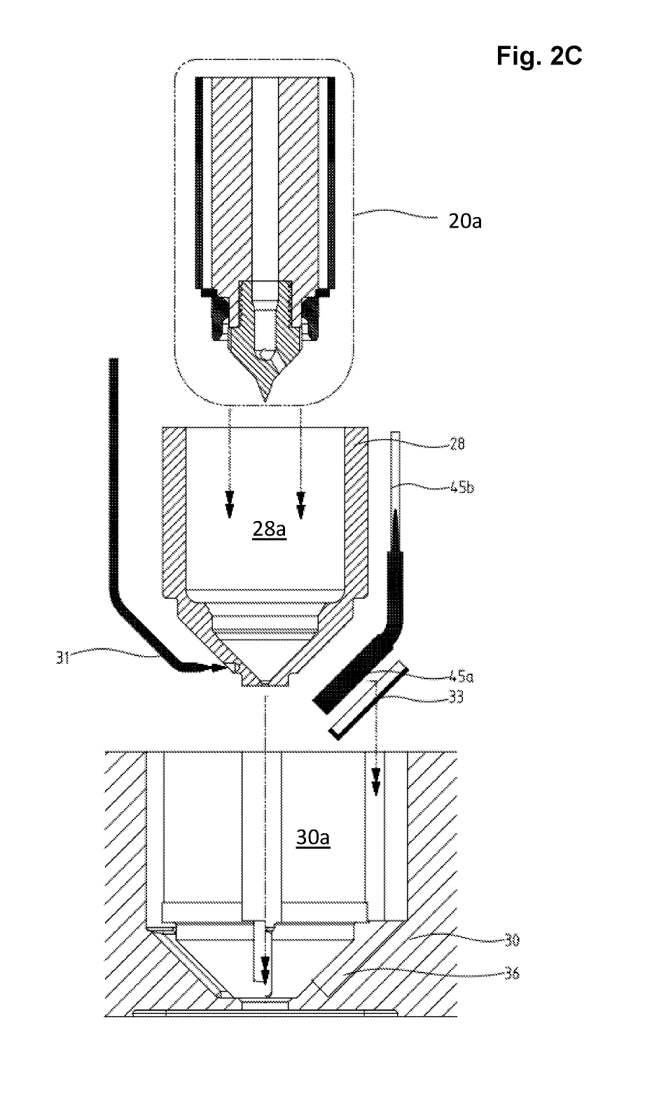

FIG. 2A shows a sectional view of a mold gate insert 28 with cartridge heaters 45a of the exemplary embodiment of a hot runner apparatus 12 with an open nozzle assembly 20 for an injection molding process from FIG. 1A. A mold gate insert 28 is arranged in a bore 30a. The bore 30a is arranged in a cavity block 30 which in the exemplary embodiment forms a part of a mold plate. An open hot runner nozzle 20a is arranged in the mold gate insert 28 having a first heating element 21 arranged at its nozzle body 22 and with a nozzle seal 26 coupled to the front end of the nozzle 20a. The nozzle seal 26 is sealingly arranged at the inner surface 28a of the mold gate insert 28 thereby positioning the nozzle tip 23 with respect to the mold gate insert 28 and the mold gate orifice 34, respectively.

In all the embodiments illustrated in FIG. 1a through FIG. 9c, the mold gate inserts 28 is separated from the hot runner nozzles 20a, 27a and from the tips 23 to prevent a direct contact and a heat transfer between them and to allow the removal of nozzles 20a, 27a via an axial translation relative to the mold gate inserts 28. The mold gate inserts 28 have an inner surface 28a, an outer surface 28 and a mold cavity surface 35 that forms at least a portion of a mold cavity 32 and an adjacent mold gate orifice 34.

Because the mold gate insert 28 is heated and the nozzle seal 26 contacts the mold gate insert 28, the invention provides new possibilities in the selection of the materials for the nozzle tip 23 and the nozzle seal 26 to use the same geometry for many nozzles and only change the materials for each specific application and for each specific resin to be molded.

In all the embodiments shown in FIG. 1A through FIG. 9c the material of the nozzle seal 28 is adapted to either reduce, maintain or enhance the heat transfer from the mold gate insert 28 heated by all heating elements 25a, 45a dependent on the resin/molten plastic material to be molded, the required cycle time and other processing factors. Accordingly, the material of the nozzle seal 26 can be the same/similar or an equivalent material as the material of the nozzle tip 23 or a different material. The material of the nozzle seal 26 is, for example, a copper or a copper alloy, a steel such as H13 or a stainless steel, or a more thermally insulative material such as, for example, titanium and its alloys, ceramics of various compositions, or polyimides (such as Vespel) or high performance plastics (such as PEEK) and defined, for example, in Wikipedia and other resources. The tip nozzle tip 23 is in some embodiments made from a material having both wear resistance and good thermal conductivity such a tungsten carbide or similar/equivalent materials. In this case the nozzle seal 26 is made either of titanium, Vespel, PEEK or a ceramic. These combinations are suitable for bot open gate and valve gated nozzles.

The material of the mold gate insert also depends on various factors such as the type of the resin/molten plastic material. For example different materials are used for the mold gate insert 28 if Engineering Thermoplastics or Commodity are a subset of plastic materials that are used in applications generally requiring higher performance in the areas of heat resistance, chemical resistance, impact, fire retardancy or mechanical strength. Engineering Thermoplastics are so named as they have properties in one or more areas that exhibit higher performance than commodity materials and are suitable for applications that require engineering to design parts that perform in their intended use.

The mold gate insert 28 is fitted within the bore 30a of the cavity block 30 along with cartridge heaters 45a for thermal equilibrium in the nozzle end portion 29. The cartridge heaters 45a are embedded in the cavity block 30 within respective cavity block groove 36 which are arranged in the section plane of FIG. 2A. In the exemplary embodiment shown in FIG. 2A, both, mold gate insert 28 and nozzle seal 26 are of high thermal conductive material, allowing the flow of heat into the nozzle end portion 29. The cartridge heaters 45a are insulated by means of an insulation element 33 arranged in the respective cavity block groove 36 to restrict the heat flow into the cavity block 30. A thermal insulation coating 99 is applied on an outer surface of the mold gate insert 28 to restrict the heat transfer to cavity block 30.

FIG. 2B shows a 3-dimensional view of a mold gate insert 28 with the mold gate orifice 34. In the exemplary embodiment a cartridge heater assembly 45 comprised of three cartridge heaters 45a is arranged at the outer surface 28b of each of the mold gate inserts 28. FIG. 2B shows the position of the cartridge heaters 45b along with the second thermocouple 31 as well as electrical wiring 45b of cartridge heaters 45a. The second thermocouple 31 is arranged near the tip area 29 for measurement of the amount of heat generated by the cartridge heater assembly 45.

FIG. 2C shows a sectional exploded view of the open nozzle 20a, the mold gate insert 28 with a cartridge heater 45a and an insulation element 33 to the right and a second thermocouple 31 to the left and the cavity block 30 of the exemplary embodiment from FIG. 2A. A cavity block groove 36 is arranged in the bore 30a of the cavity block 30 for receiving the insulation element 33 and the cartridge heater 45a. The elements are shown with an assembly sequence indicated by arrows.

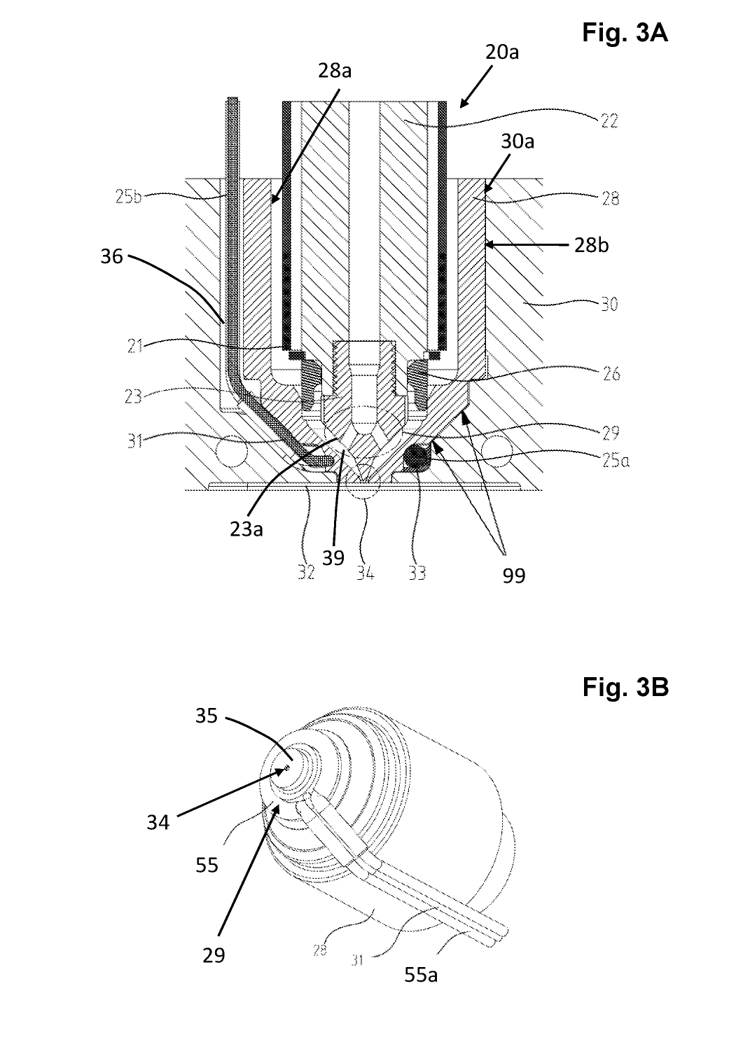

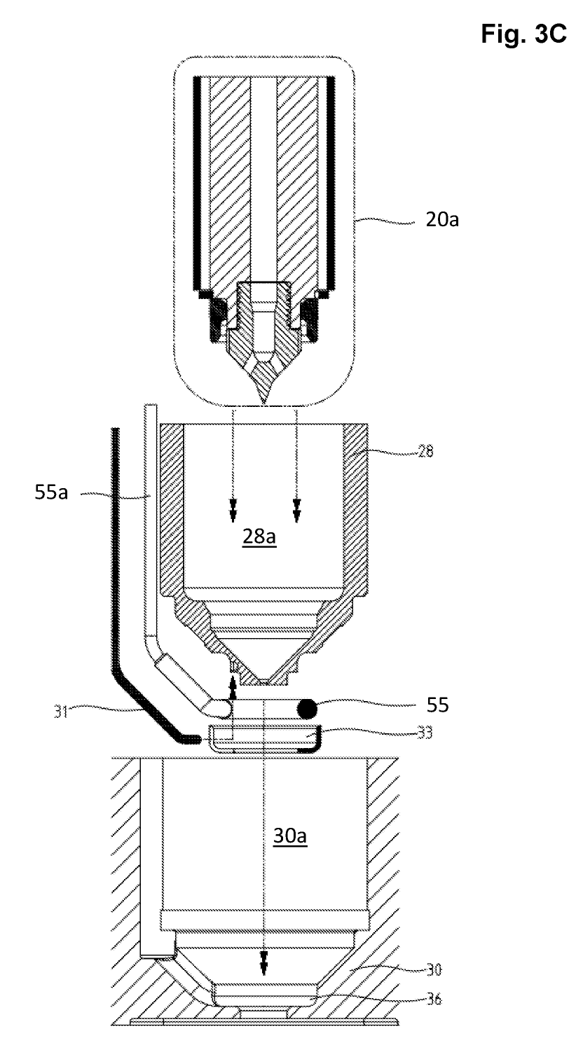

FIG. 3A shows a sectional view of a mold gate insert 28 with a coiled heater 55 according to a further exemplary embodiment of a hot runner apparatus 12 with an open nozzle assembly 20 for an injection molding process. A mold gate insert 28 is arranged in a bore 30a. The bore 30a is arranged in a cavity block 30 which in the exemplary embodiment forms part of a mold plate. An open hot runner nozzle 20a is arranged in the mold gate insert 28 having a first heating element 21 arranged at its nozzle body 22 and with a nozzle seal 26 coupled to the front end of the nozzle 20a. The nozzle seal 26 is sealingly arranged at the inner surface 28a of the mold gate insert 28 thereby positioning the nozzle tip 23 with respect to the mold gate insert 28 and the mold gate orifice 34, respectively.

The open nozzle 20a is fitted in the mold gate insert 28 along with a coiled heater 55 for thermal equilibrium in the nozzle end portion 29. In FIG. 3A both mold gate insert 28 and nozzle seal 26 are of high thermal conductive material, allowing the flow of heat into the end portion 29. Nevertheless, depending on the resin to be molded also different combinations of materials can be used, as already mentioned before. A coil of the coiled heater 55 encircles the outer surface 28b of the mold gate insert 28 adjacent to the mold gate orifice 34. The second thermocouple 31 for measurement of the amount of heat generated by the coiled heater 55 is arranged near the nozzle end portion 29 being also accommodated within a cavity block groove 36 in the bore 30a of the cavity block 30. The bore 30a is designed with cavity block grooves 36 for receiving the coiled heater 55 and the second thermocouple 31, respectively. At the coiled heater 55 an insulation element 33 is arranged for restricting the flow of heat into the cavity block 30. Also in the embodiment shown in FIG. 3A, a thermal insulation coating 99 is applied on outer surface of the mold gate insert 28 to restrict the heat transfer in cavity block 30. The second heating element 25a is configured to heat up the bubble area 39 defined between the inner surface 28a of the mold gate insert 28, an outer surface 23a of the nozzle tip 23, and the nozzle seal 26, to provide removal of a resin accumulation in the bubble area 39 between subsequent injection steps.

FIG. 3B shows a 3-dimensional view of a mold gate insert 28 with the mold gate orifice 34. In the exemplary embodiment of FIG. 3A, a coiled heater 55 is arranged at the outer surface 28b of each of the mold gate inserts 28. As is shown in FIG. 3B, the coil of the coiled heater 55 encircles the outer surface 28b of the mold gate insert 28 adjacent to the mold gate orifice 34 and touches the mold gate insert 28. The bore 30a of the cavity block 30 is designed with corresponding cavity block grooves 36 for receiving the coiled heater 55 and the second thermocouple, respectively. In FIG. 3B the coiled heater 55 along with the second thermocouple 31 as well as the electrical wiring 55a of the coiled heater 55 is shown. FIG. 3B shows the position of the coiled heater 55 along with the thermocouple 31 which is arranged near the nozzle end portion 29.

FIG. 3C shows a sectional exploded view of the open nozzle 20a, the mold gate insert 28 with a coiled heater 55 and an insulation element 33, a second thermocouple 31 and the cavity block 30 of the exemplary embodiment from FIG. 3A. In the bore 30a of the cavity block 30 a cavity block groove 36 is arranged circumferentially to the mold gate orifice 34 for receiving the insulation element 33 and the coiled heater 55. The elements are shown with an assembly sequence indicated by arrows.

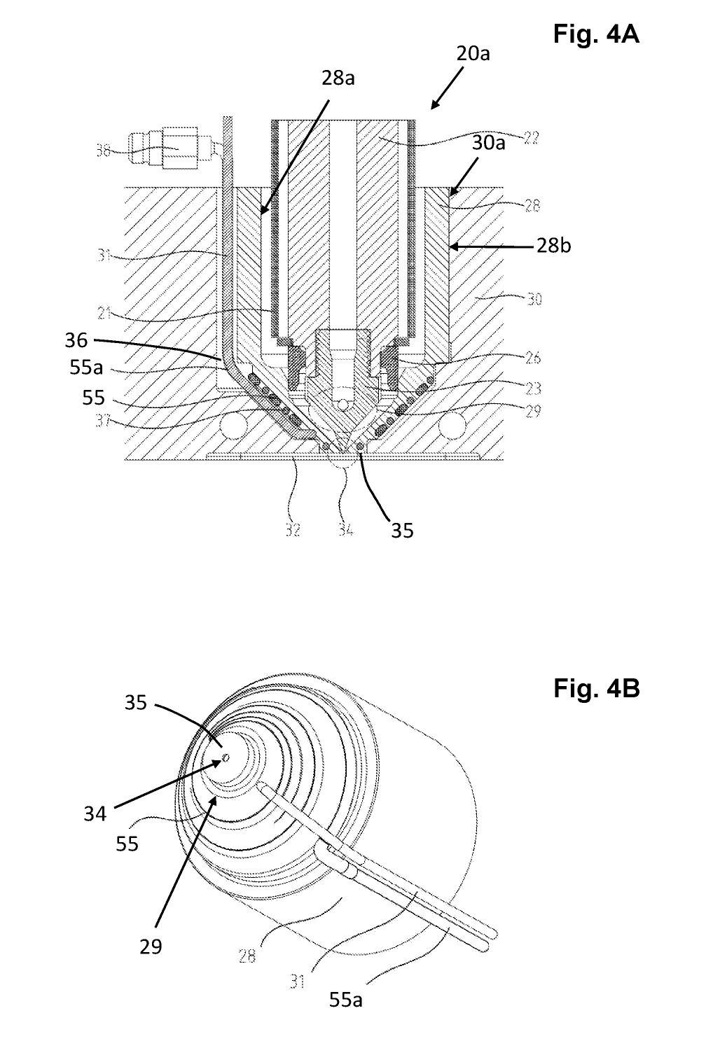

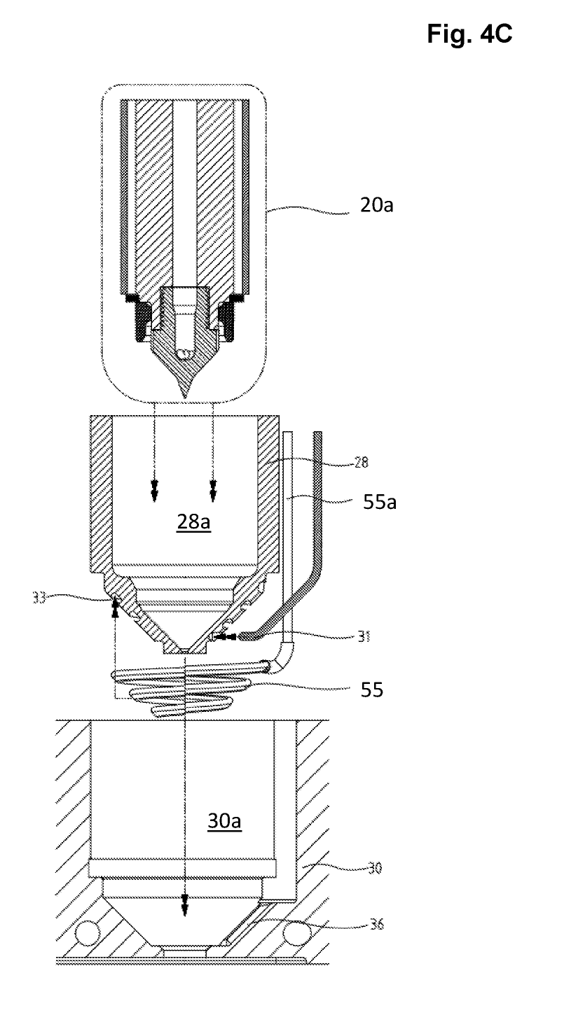

FIG. 4A shows a sectional view of a mold gate insert 28 with an embedded coiled heater 55 and a cooling device 37 according to a further exemplary embodiment of a hot runner apparatus 12 with an open nozzle assembly 20 for an injection molding process. A mold gate insert 28 is fitted in a bore 30a along with the embedded coiled heater 55 and the cooling device 37 in form of cooling pipes 37a for thermal equilibrium in the nozzle end portion 29 of the mold gate insert 28. The bore 30a is arranged in a cavity block 30 which in the exemplary embodiment forms part of a mold plate. An open hot runner nozzle 20a is arranged in the mold gate insert 28 having a first heating element 21 arranged at its nozzle body 22 and with a nozzle seal 26 coupled to the front end of the nozzle 20a. The nozzle seal 26 is sealingly arranged at the inner surface 28a of the mold gate insert 28 thereby positioning the nozzle tip 23 with respect to the mold gate insert 28 and the mold gate orifice 34, respectively.

The open nozzle 20a is fitted in the mold gate insert 28. In FIG. 4A both mold gate insert 28 and nozzle seal 26 are of high thermal conductive material, allowing the flow of heat into the nozzle end portion 29. Nevertheless, depending on the resin to be molded different combinations of materials can be used, as already mentioned before. Several coils of the coiled heater 55 are helically arranged within corresponding recesses formed at the tapered outer surface 28b of the mold gate insert 28 adjacent to the mold gate orifice 34. Cooling pipes 37a are helically arranged between the coils of the coiled heater 55 at the tapered outer surface 28b of the mold gate insert 28 adjacent to the mold gate orifice 34. Also the cooling pipes 37a are embedded within the outer surface 28a of the mold gate insert 28. A cooling gas is provided through the inlet 38 of the cooling device.

The second thermocouple 31 for measurement of the amount of heat generated by the coiled heater 55 is arranged near the nozzle end portion 29 being accommodated within a cavity block groove 36 in the bore 30a of the cavity block 30. The bore 30a is also designed with cavity block grooves 36 for receiving the second thermocouple 31. At the coiled heater 55 an insulation element 33 is arranged for restricting the flow of heat into the cavity block 30.

FIG. 4B shows a 3-dimensional view of a mold gate insert 28 with the mold gate orifice 34. In the exemplary embodiment of FIG. 3A, a coiled heater 55 and cooling pipes 37a are embedded in the outer surface 28b of each mold gate insert 28. Coils of the coiled heater 55 and heat pipes 37 of the cooling device are embedded in the outer surface 28b of the mold gate insert 28 adjacent to the mold gate orifice 34. The bore 30a of the cavity block 30 is designed with a corresponding cavity block groove 36 for receiving the second thermocouple 31. In FIG. 4B the coiled heater 55 along with the second thermocouple 31 as well as the electrical wiring 55a of the coiled heater 55 is shown. FIG. 4B shows the position of the coiled heater 55 along with the thermocouple 31 which is arranged near the nozzle end portion 29.

FIG. 4C shows a sectional exploded view of the open nozzle 20a, the mold gate insert 28 with a coiled heater 55 and a second thermocouple 31 and the cavity block 30 of the exemplary embodiment from FIG. 4A. An insulation element 33 is arranged within the grooves for the coiled heater 55 at the tapered front portion of the mold gate insert. A cavity block groove 36 is arranged in the bore 30a of the cavity block 30 for receiving the second thermocouple 31. The elements are shown with an assembly sequence indicated by arrows.

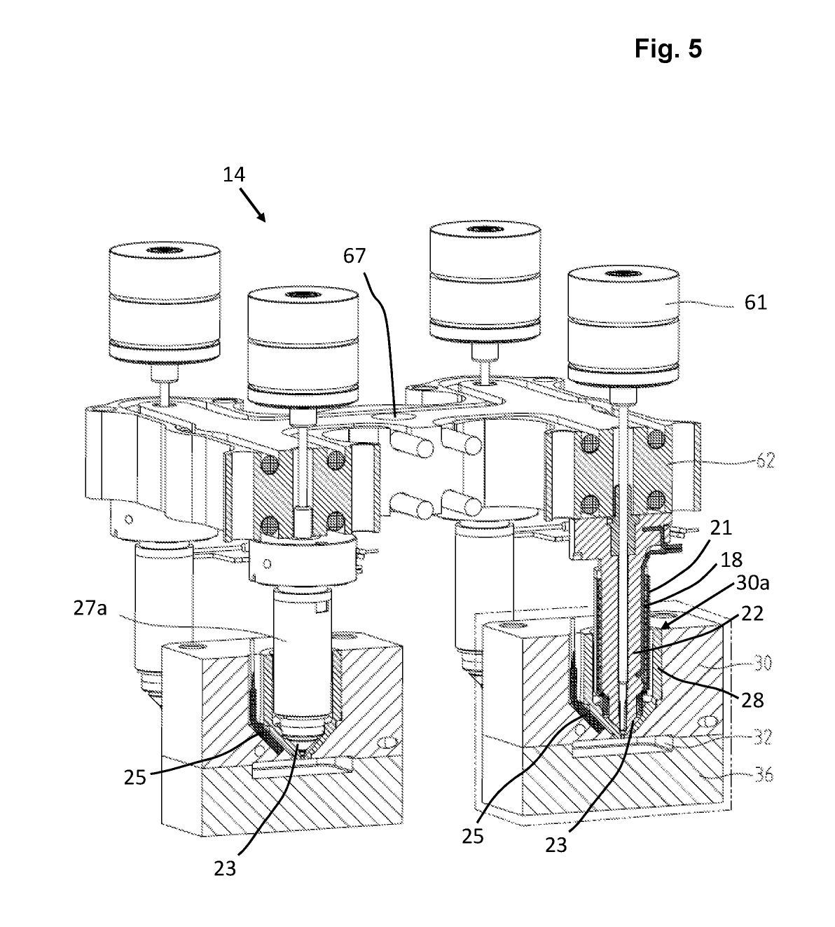

FIG. 5 shows a further exemplary embodiment of an inventive hot runner apparatus 14 with valve gated nozzles 27a (also known as valve pin nozzles or valve gating nozzles) for an injection molding process. In the same way as the hot runner apparatus 12 as shown in FIGS. 1A to 4C, the hot runner apparatus 14 serves for an injection molding processes and comprises a valve gated nozzle assembly 27 (in the exemplary embodiment four nozzles; the number of nozzles comprised in a valve gated nozzle assembly depends on the application and may be two or more than four, up to 64 or 128 nozzles are also possible) coupled to a hot runner manifold 62 having a manifold inlet 67 to receive molten plastic material and a plurality of manifold outlets (not shown). The hot runner nozzles 27a are located in individual bores 30a of a mold plate which comprises cavity blocks 30 in the exemplary embodiment of FIG. 5. In each cavity block 30 an impression is arranged which forms a part of the mold cavity 32. The valve pins 24 of the valve gated nozzles 27a are actuated by means of a pneumatic system 61 for controlling the flow of melt into the impression and thereby into the mold cavity 32.

Each valve gated hot runner nozzle 27a includes a nozzle body 22 with a nozzle tip 23 formed integrally with the nozzle body 22. Corresponding to the open nozzles 20a shown in the exemplary embodiments of FIGS. 1A to 4C, each valve gated hot runner nozzle 27a further includes a first heating element 21 coupled to the nozzle body 22 and a first thermocouple 18 to measure an amount of heat generated by the first heater 21. The exemplary hot runner apparatus 14 comprises four mold gate inserts 28 located in bores 30a of cavity blocks 30. The cavity blocks 30 as well as the mold gate inserts 28 of the hot runner apparatus 14 are designed corresponding to hot runner apparatus 12 shown in FIGS. 1A to 4C. The front end of the nozzle 27a is arranged in proximity to an inner surface 28a of the mold gate insert 28. Each mold gate insert 28 is heated by a second heating element 25. An amount of heat generated by the second heating element 25 is measured by a second thermocouple 31.

The exemplary hot runner apparatus 14 further comprises four nozzle seals 26 each coupled to a valve gated nozzle 27a. The nozzle seal 26 makes contact with the inner surface 28a of the mold gate insert 28 and provides sealing and an alignment of the respective nozzle 20a with respect to the mold gate orifice 34 and limits the heat transfer from the nozzle 27a to the mold gate insert 28. A controller 137 (not shown in FIG. 5) is connected to the hot runner apparatus 12 which is configured to receive temperature data from the first thermocouple 18 and the second thermocouple 31 and for adjusting the first heating element 21 and the second heating element 25 independently from each other.

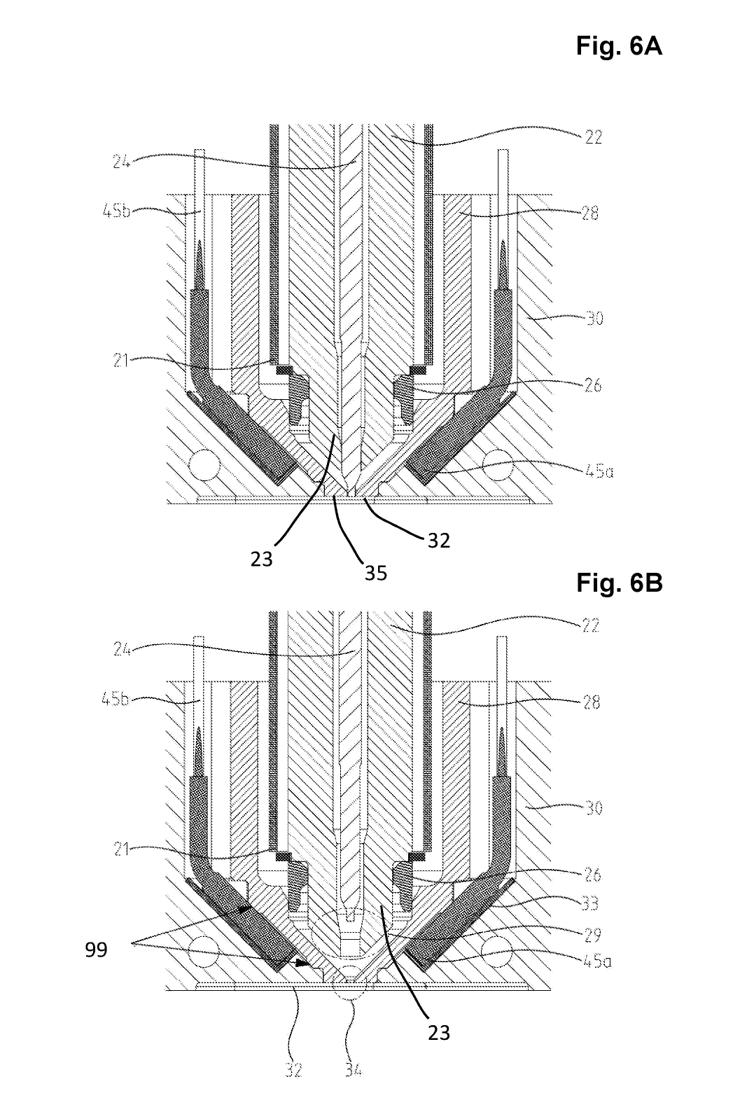

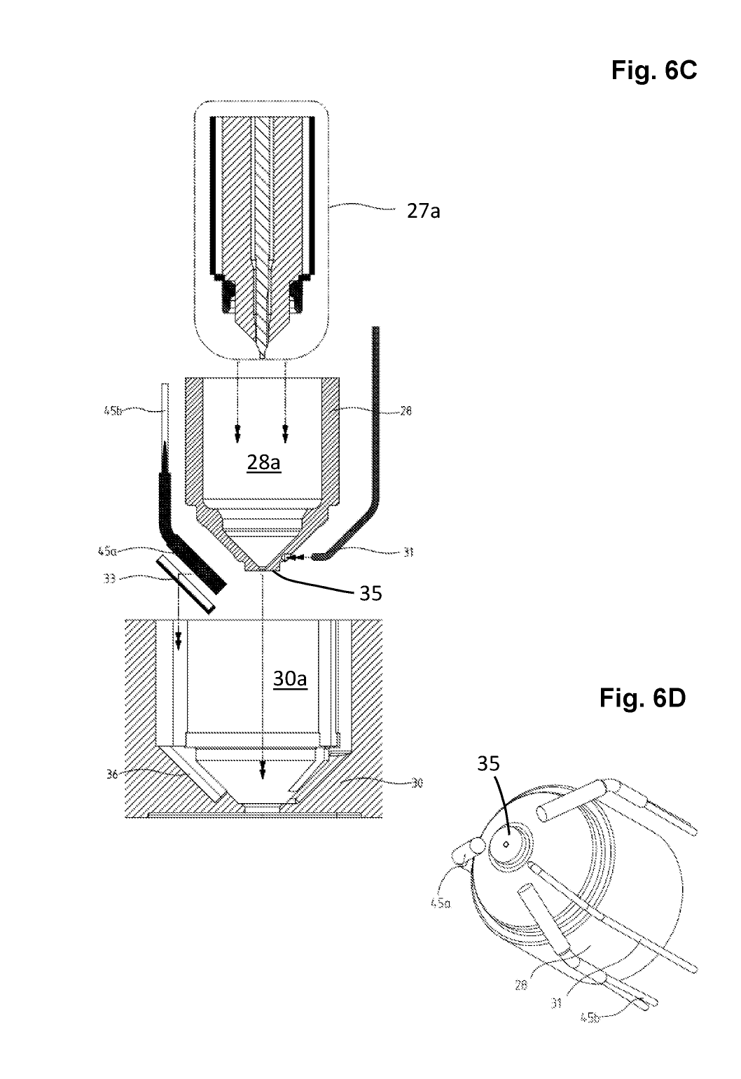

FIGS. 6A to 6D show different views of the mold gate insert 28 with cartridge heaters 45a of the exemplary embodiment from FIG. 5. The design and functions of the elements shown in FIGS. 6A to 6D correspond to a large extent to the design and functions of the elements shown in FIGS. 2A to 2C. Therefore, in the following the description will focus on the differences between these two embodiments.

FIGS. 6A and 6B show sectional views of a mold gate insert 28 with cartridge heaters 45a of the exemplary embodiment of a hot runner apparatus 14 with a valve gated nozzle assembly 27 for an injection molding process from FIG. 5. FIGS. 6A and 6B correspond to each other except that FIG. 6A shows the valve pin 24 in a closed position where the flow of melt into the mold cavity 32 is interrupted while FIG. 6B shows the valve pin 24 in an open position where melt can flow into the mold cavity 32.

A mold gate insert 28 is arranged in a bore 30a of a cavity block 30 forming a part of a mold plate. A first heating element 21 and a first thermocouple 18 are arranged at the nozzle body 22. A nozzle seal 26 is coupled to the nozzle tip 23, sealingly arranged at the inner surface 28a of the mold gate insert 28 thereby positioning the nozzle tip 23.

For thermal equilibrium in the nozzle end portion 29 the mold gate insert 28 is fitted within the cavity block 30 along with cartridge heaters 45a which are embedded in the cavity block 30. Both, mold gate insert 28 and nozzle seal 26 are of high thermal conductive material, allowing the flow of heat into the nozzle end portion 29. The cartridge heaters 45a are insulated by means of an insulation element 33 which restricts the heat flow into the cavity block 30. A thermal insulation coating 99 is applied on an outer surface 28b of the mold gate insert 28 to restrict the heat transfer to cavity block 30. Nevertheless, depending on the resin to be molded different combinations of materials can be used, as already mentioned before. The second heating element 45a is configured to heat up the mold gate orifice 34 to a temperature dependent on the resin that allows removal of a resin plug formed between injection cycles.

FIG. 6C shows a sectional exploded view of the valve gated nozzle 27a, the mold gate insert 28 with a cartridge heater 45a and an insulation element 33 to the left and a second thermocouple 31 to the right and the cavity block 30 of the exemplary embodiment from FIG. 6A to 6C. A cavity block groove 36 is arranged in the bore 30a for receiving the insulation element 33 and the cartridge heater 45a. The elements are shown with an assembly sequence indicated by arrows.

FIG. 6D shows a 3-dimensional view of a mold gate insert 28. A cartridge heater assembly 45 comprised of three cartridge heaters 45a is arranged at the outer surface 28b along with a second thermocouple 31. The second thermocouple 31 is arranged near the nozzle end portion 29 for measurement of the amount of heat generated by the cartridge heater assembly 45.

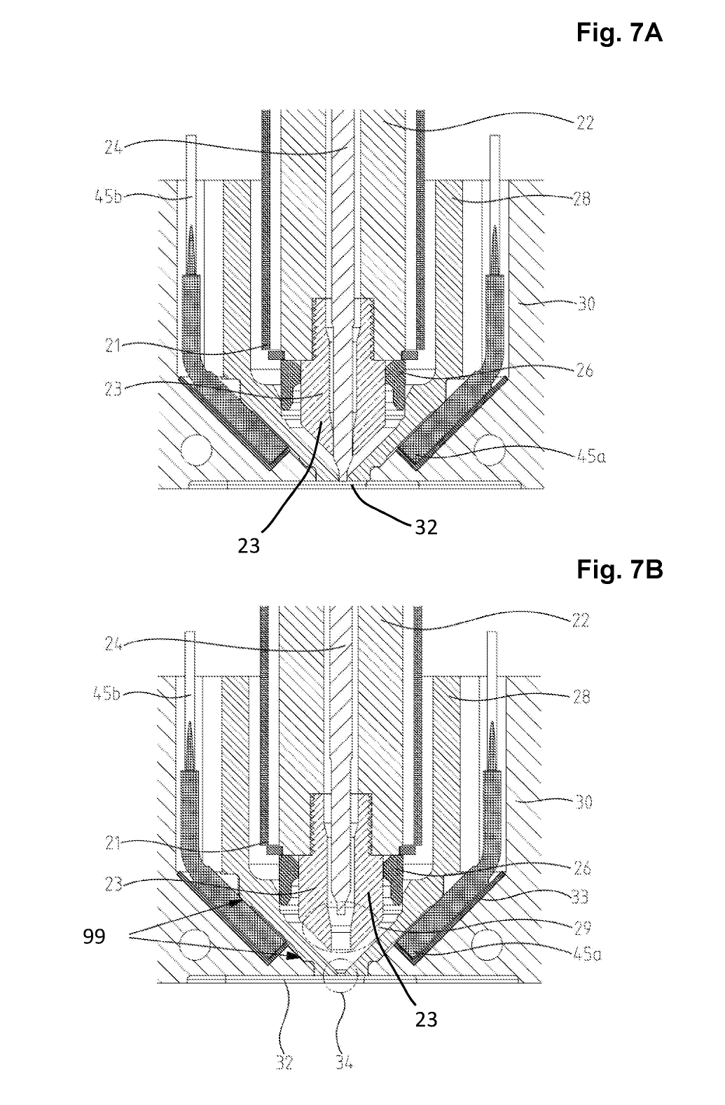

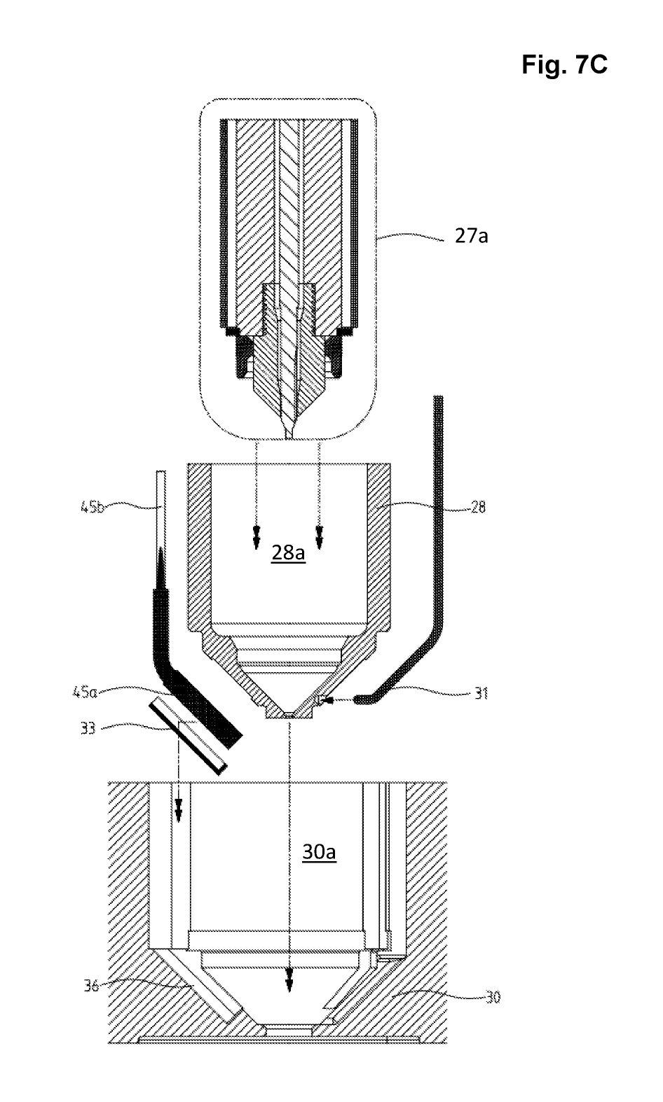

FIGS. 7A to 7C show different views of the mold gate insert 28 with cartridge heaters 45a and a replaceable nozzle tip 23 of a further exemplary embodiment of an inventive hot runner apparatus 14 with valve gated nozzles 27a. The design and functions of the elements shown in FIGS. 7A to 7C correspond to the design and functions of the elements shown in FIGS. 6A to 6C with the exception that a valve gated nozzle 27a comprises a nozzle body 22 and a separate nozzle tip 23 mounted to the nozzle body 22. Compared with the embodiment of FIGS. 6A to 6C, the nozzle tip 23 may be manufactured from a material having a different thermal conductivity than the nozzle body. This allows one to increase or decrease the heat flow within the nozzle tip 23 and between the nozzle tip 23 and the nozzle body 22.

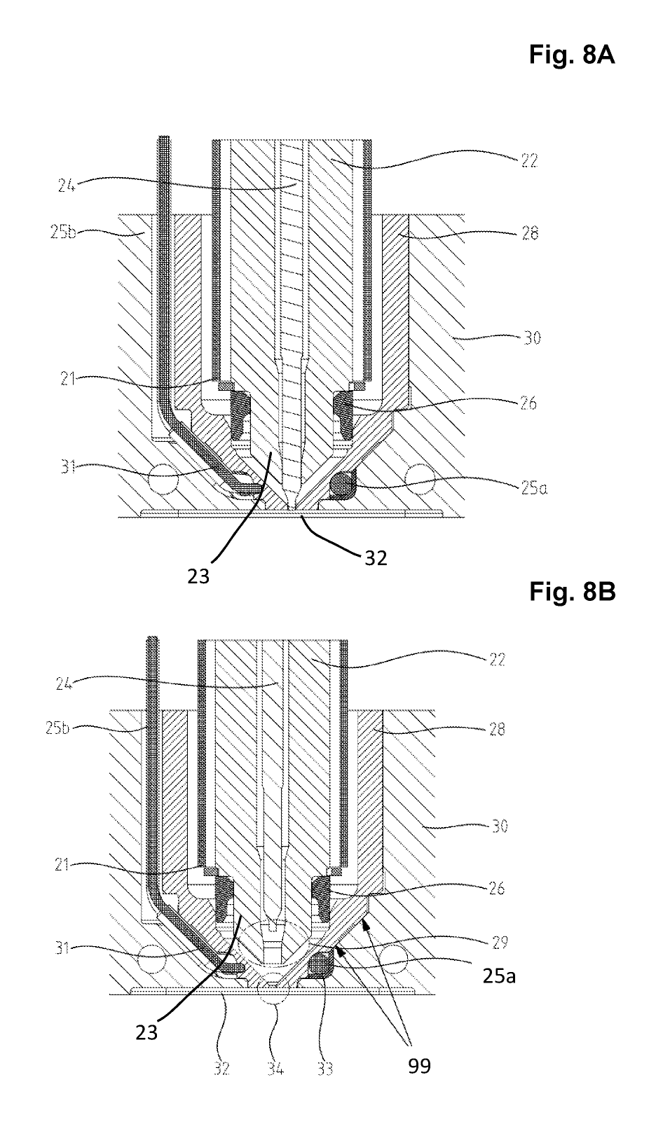

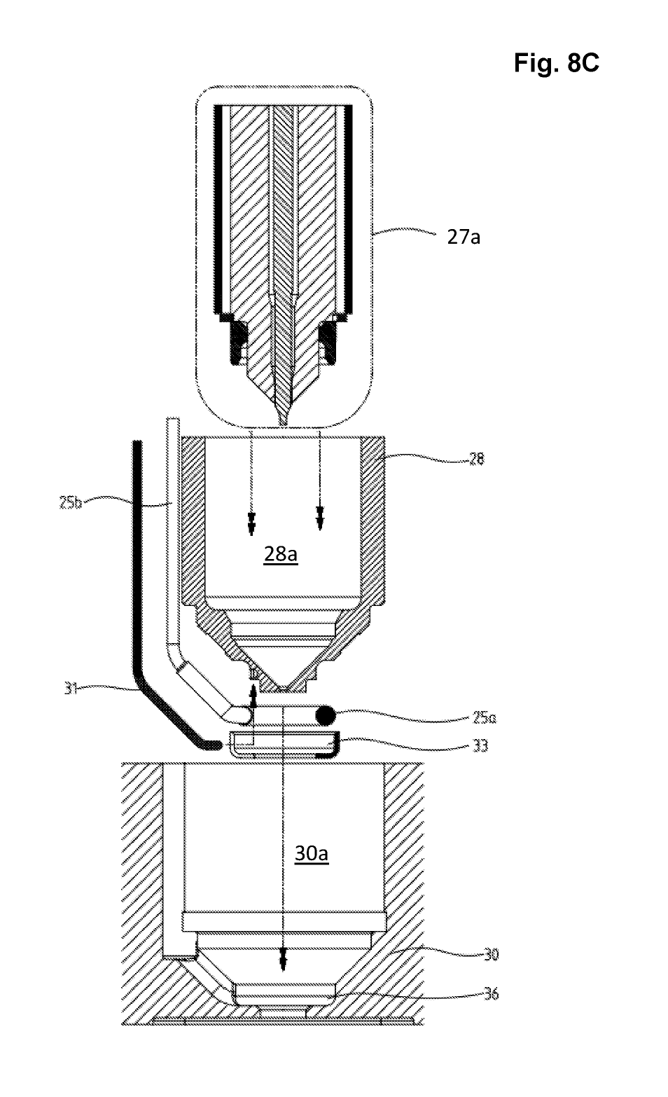

FIGS. 8A to 8C show different views of the mold gate insert 28 with a coiled heater 25a of a further exemplary embodiment of an inventive hot runner apparatus 14 with valve gated nozzles 27a. The design and functions of the elements shown in FIGS. 8A to 8C correspond to a large extent to the design and functions of the elements shown in FIGS. 3A and 3C. Therefore, in the following the description will focus on the differences between these two embodiments.

Compared with the embodiment of FIGS. 3A and 3C, the embodiment of FIGS. 8A to 8C comprises a valve gated hot runner nozzle assembly 27 with valve gated nozzles 27a having a nozzle tip 23 formed integrally with the nozzle body 22. FIGS. 8A and 8B show sectional views of a mold gate insert 28 with a coiled heater 25a of the exemplary embodiment of a hot runner apparatus 14 with a valve gated nozzle assembly 27 for an injection molding process from FIG. 5. FIGS. 8A and 8B correspond to each other except that FIG. 8A shows the valve pin 24 in a closed position where the flow of melt into the mold cavity 32 is interrupted while FIG. 8B shows the valve pin 24 in an open position where melt can flow into the mold cavity 32.

FIG. 8C shows a sectional exploded view of the valve gated nozzle 27a, the mold gate insert 28 with a coiled heater 55 and an insulation element 33, a second thermocouple 31 and the cavity block 30 of the exemplary embodiment from FIGS. 8A and 8B. In the bore 30a of the cavity block 30 a cavity block groove 36 is arranged circumferentially to the mold gate orifice 34 for receiving the insulation element 33 and the coiled heater 55. The elements are shown with an assembly sequence indicated by arrows.

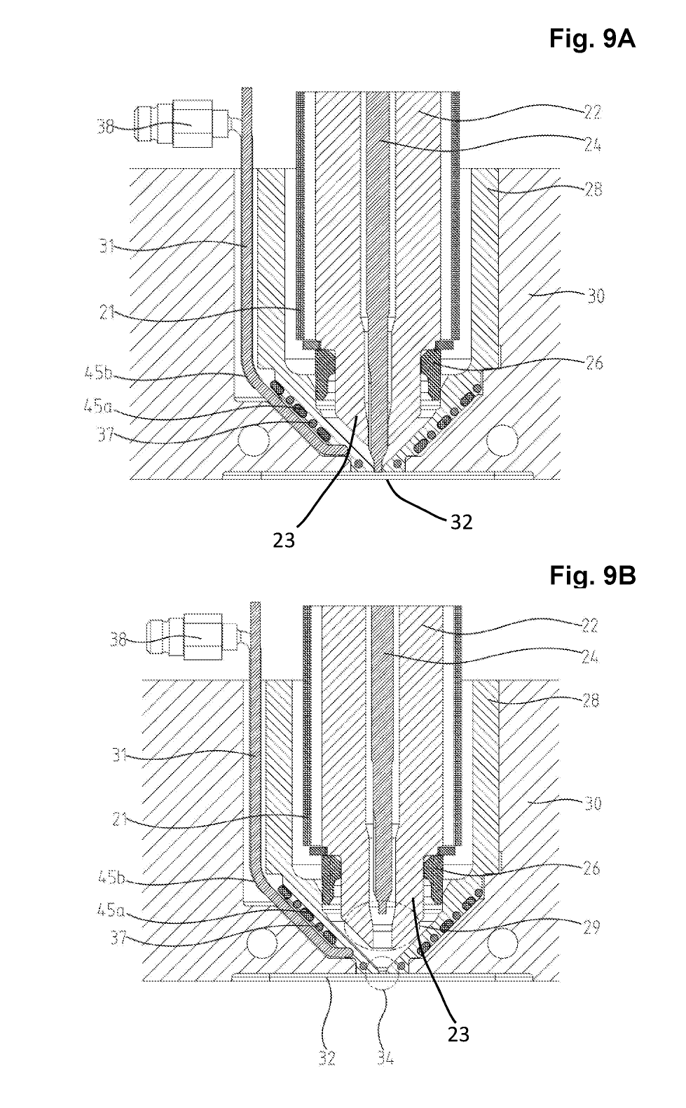

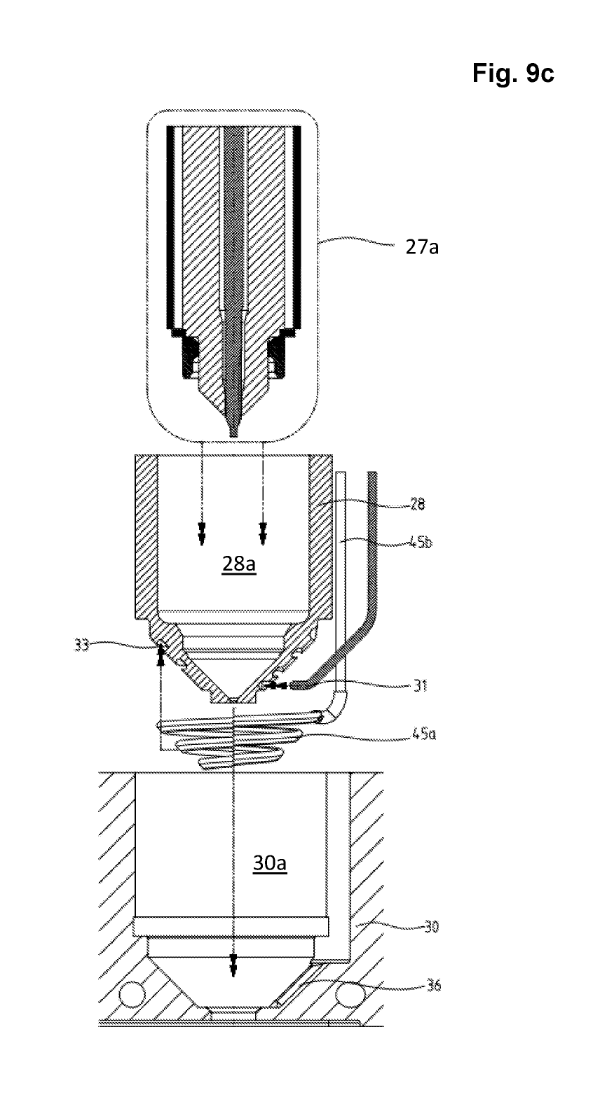

FIGS. 9A to 9C show different views of the mold gate insert 28 with an embedded coiled heater 55 and a cooling device 37 of a further exemplary embodiment of an inventive hot runner apparatus 14 with valve pin nozzles. The design and functions of the elements shown in FIGS. 9A to 9C correspond to a large extent to the design and functions of the elements shown in FIGS. 4A and 4C. Therefore, in the following the description will focus on the differences between these two embodiments.

Compared with the embodiment of FIGS. 4A and 4C, the embodiment of FIGS. 9A to 9C comprises a valve gated hot runner nozzle assembly 27 with valve gated nozzles 27a having a nozzle tip 23 formed integrally with the nozzle body 22. FIGS. 9A and 9B show sectional views of a mold gate insert 28 with a coiled heater 55 of the exemplary embodiment of a hot runner apparatus 14 with a valve gated nozzle assembly 27 for an injection molding process from FIG. 5. FIGS. 9A and 9B correspond to each other except that FIG. 9A shows the valve pin 24 in a closed position where the flow of melt into the mold cavity 32 is interrupted while FIG. 9B shows the valve pin 24 in an open position where melt can flow into the mold cavity 32.

FIG. 9C shows a sectional exploded view of the valve gated nozzle 27a, the mold gate insert 28 with a coiled heater 55 and a second thermocouple 31 and the cavity block 30 of the exemplary embodiment from FIGS. 9A and 9B. An insulation element 33 is arranged within the grooves for the coiled heater 55 at the tapered front portion of the mold gate insert. The elements are shown with an assembly sequence indicated by arrows.

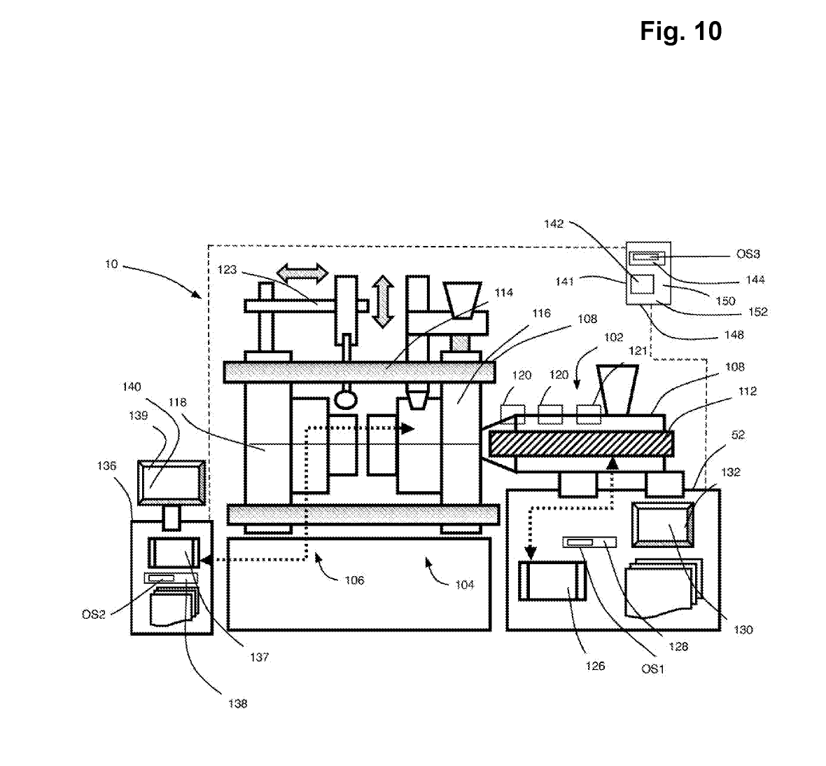

FIG. 10 shows a schematic illustration of an exemplary embodiment of an inventive hot runner apparatus comprising a controller for adjusting at least the heat output of the first and second heating elements.

FIG. 10 shows a hot runner injection molding system 10. The injection molding system 10 includes an injection molding machine 102, comprising a mold plate 104. The injection molding machine 102 includes an injection unit 108 and a clamping unit 110. The clamping unit 110 may include a plurality of hydraulic rams 114 that bring a first platen 116 and a second platen 118 towards and away from each other. A hot runner apparatus 12 or 14 of one of the exemplary embodiments can be arranged at the first platen 116. The hot runner apparatus 12, 14 further comprises a controller 137 configured to receive temperature data from the first thermocouple 18 and the second thermocouple 31 from each nozzle 20a, 27a, serving to adjust the first heating element 21 and the second heating element 25 independently from each other. The first and second thermocouples 18, 31 are arranged at the nozzles 20a, 27a and are connected to the controller 137. The controller 137 may be integrated in the general controller of the hot runner injection molding system 10. Also a plurality of processing sensors 120 may be provided to detect, among other things, the pressure of the molten material, motor current draw on the motors and any other suitable processing information. The sensors 120 are examples for further injection molding machine sensors and any other type of sensor may additionally or alternatively be provided for controlling the hot runner injection molding system 10 and the heat output of the first and second heating elements 21, 25.

Some of the elements described herein are identified explicitly as being optional, while other elements are not identified in this way. Even if not identified as such, it will be noted that, in some embodiments, some of these other elements are not intended to be interpreted as being necessary, and would be understood by one skilled in the art as being optional.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

1. An injection molding apparatus comprising:
a manifold having a manifold inlet to receive molten plastic or resin material and a plurality of manifold outlets;
a plurality of hot runner nozzles coupled to the manifold outlets, the hot runner nozzles being located in individual bores of a mold plate, each hot runner nozzle including a nozzle body and a nozzle tip, the hot runner nozzle further including a first heating element coupled to the nozzle body and a first thermocouple to measure an amount of heat generated by the first heating element;
a plurality of mold gate inserts located in the bores and in the proximity of the nozzle tips, the mold gate inserts being separated from the nozzles and from the nozzle tips to prevent a direct contact and a heat transfer between them and to allow the removal of nozzles via an axial translation relative to the mold gate inserts, and where the mold gate inserts have an inner surface, an outer surface, and a mold cavity surface that forms at least a portion of a mold cavity adjacent to the mold gate orifice, each mold gate insert being heated by a second heating element, where an amount of heat generated by the second heating element is measured by a second thermocouple;
a plurality of nozzle seals coupled to the nozzles, the nozzle seal making contact with the inner surface of the mold gate insert and providing sealing and an alignment of the nozzle with respect to the mold gate orifice and whereby the nozzle seals further limit a heat transfer from the nozzle to the mold gate insert when the second heating element is activated; and
a controller configured to receive temperature data from the first thermocouple and the second thermocouple and to adjust independently the first heating element and the second heating element.

2. The injection molding apparatus of claim 1, wherein the nozzle seal is made of a material having a lower thermal conductivity than the material of the nozzle tip to provide thermal insulation of the tip relative to the mold gate insert.

3. The injection molding apparatus of claim 1, wherein the nozzle seal is made of a material having the same thermal conductivity as the material of the nozzle tip to allow a heat transfer from the mold gate insert to the nozzle tip.

4. The injection molding apparatus of claim 1, wherein the nozzle seal is made of a material having a higher thermal conductivity than the material of the nozzle tip to enhance the heat transfer from the mold gate insert to the nozzle tip.

5. The injection molding apparatus of claim 1, wherein the hot runner nozzle is an open gating nozzle, and the second heating element is configured to heat up a bubble area defined between the inner surface of the mold gate insert, an outer surface of the nozzle tip, and the nozzle seal, to provide removal of a resin accumulation in the bubble area between subsequent injection steps.

6. The injection molding apparatus of claim 1, wherein the hot runner nozzle is a valve gating nozzle and wherein the second heating element is configured to heat up the mold gate orifice to a temperature dependent on the resin that allows removal of a resin plug formed between injection cycles.

7. The injection molding apparatus of claim 1, wherein the nozzle tip is integrally formed with the nozzle body.

8. The injection molding apparatus of claim 1, wherein the nozzle tip is separate from the nozzle body.

9. The injection molding apparatus of claim 8, wherein the nozzle tip is made of a different material than the nozzle body.

10. The injection molding apparatus of claim 1, wherein the second heating element for heating the mold gate insert is a removable heating element.

11. The injection molding apparatus of claim 1, wherein the second heating element for heating the mold gate insert is an embedded heating element.

12. The injection molding apparatus of claim 1, wherein the second heating element for heating the mold gate insert includes at least one linear cartridge heater.

13. The injection molding apparatus of claim 1, wherein the second heating element for heating the mold gate insert includes at least one heating element having a coiled heater or a linear cartridge heater.

14. The injection molding apparatus of claim 1, wherein the mold gate insert includes a cooling device for use after the injection step.

15. The injection molding apparatus of claim 14, wherein the cooling device is water based.

16. The injection molding apparatus of claim 14, wherein the cooling device is gas based.

17. The injection molding apparatus of claim 1, wherein a thermal insulation coating is applied on an outer surface of the mold gate insert.
